(19) United States
(12) Patent Application Publication
(10) Pub. No.: US 2024/0127163 A1
(43) Pub. Date: Apr. 18, 2024

(54) Trusted order and delivery system

(71) Applicant: Baiju Dhirajlal Mandalia, Boca Raton, FL (US)

(72) Inventor: Baiju Dhirajlal Mandalia, Boca Raton, FL (US)

(21) Appl. No.: 18/047,257

(22) Filed: Oct. 17, 2022

(51) Int. Cl. G06Q 10/0833; G06Q 10/0832; G06Q 50/12

(52) U.S. Cl. CPC G06Q 10/0833; G06Q 10/0832; G06Q 50/12

(57) ABSTRACT

An approach for a secure food delivery container and process is provided. Use of blockchain, machine learning and analytics to create a trusted end to end delivery of restaurant food, pharmaceutical, medical and e-commerce product to their respective customers is shown. The container includes internal environmental control using CPU, memory, transceiver, sensors as well as an electronic lock that exploits Wi-Fi and GPS location methods. A centralized cloud is system is described to enable use of blockchain methods for recording and transmitting the transactions.

### TECHNICAL FIELD

This invention relates to trusted food ordering and delivery systems and business models. We are proposing a end to end architecture for secure and safe food delivery.

### BACKGROUND OF ART

During the pandemic, we have experienced significant disruptions in hospitality business and supply chain. If there was a trusted process for delivery, significant food waste could have been prevented. Prior art has suggested mechanisms for environmentally safe recording and traceability in food supply operation. For restaurant ordering of real time ordered cooked food, there are several challenges in terms of quantity, ingredients, method to prepare and secure delivery of the food.

Artificial Intelligence and Machine learning are being adopted for video verification of quality in many business application. In machine learning, statistical methods and algorithms are trained to make classifications to uncover key insights within data. These insights are help drive decision making within applications and businesses processes.

Technology and applications for online real-time ordering and delivery of fresh and restaurant food have evolved in the past decade, however there are some disadvantages in the food delivery process.

### SUMMARY ON INVENTION

This invention exploits cloud, internet of things (IOT), machine learning and blockchain technologies to provide a robust trusted solution for real time food ordering and delivery for personal consumption.

Blockchain is a distributed ledger that can be used to securely record, store and manage data associated with transactions in multiple domains. Blockchain is being configured to enable trusted business transactions.

In a situation of a pandemic, there has been a high demand for food order and delivery due to restrictions with indoor dining. There is an obvious loss of quality in terms of fresh consumption of cooked food and time delayed delivery.

There are two use cases the embodiment will service. Spontaneous ordering of food for one time delivery from a local service provider or pre-scheduled periodic and recurring delivery of pre-packaged meals and shipped across geographies.

One method is provided for a secure container with an electronic lock.

Another embodiment provides a system whereby the electronic lock is controlled by the food provider and accessible by the ordering consumer only and secured.

Another embodiment provides a system whereby the customer Wi-Fi and GPS location and a code sent via text from the food provider/restaurant seller at the time of delivery are used to access the lock. Wi-Fi is a family of wireless network protocols, based on the IEEE 802.11 family of standards, which are commonly used for local area networking of devices and location services. GPS is a global positioning system utility that provides users with positioning, navigation, and timing services integrated into hardware endpoint solutions.

Another embodiment provides a system whereby there are separate sections in the container with individual temperature controls using internet of things sensor technologies.

Another embodiment provides a system whereby real time photos and videos of food items while cooked and packed into the secure container available with time stamp are available on the cloud entry associated with the secure container.

Another embodiment provides a system whereby artificial intelligence and machine learning based techniques are used to validate patterns associated with quantity, ingredients and environment of the food items through the delivery process by exploiting video and weight of the food items.

Another embodiment provides a system whereby private identities of staffed involved with preparing, packing and delivery of the secure container are stored in the cloud entry associated with the secure container.

All data associated with the above aspects ordering process are stored and traceable via blockchain for any realtime and analytical needs.

### BRIEF DESCRIPTION OF THE FIGURES

FIG. 1: Logical view of system: This block diagram shows logical view of an exemplary system architecture for various embodiments including restaurant, pharmaceutical, medical and e-commerce.

FIG. 2: Enterprise view of the system: This block diagram shows physical elements in the system

FIG. 3: Logical view of Secure Delivery Container: This block diagram shows the logical elements of the secure container

FIG. 4: Physical view of the Secure Delivery container: This block diagram shows physical elements in the secure container with internet of things sensor technology

FIG. 5: Logical view of the Blockchain System: This block diagram shows the logical elements of the Blockchain for Delivery records

FIG. 6: Flowchart: Block diagram depicting the program steps from order to delivery

FIG. 7: Flowchart: Block diagram depicting the program steps for lock and unlock of the secure container.

FIG. 8: Use Case: Use Case 1—one time food order from local restaurant

FIG. 9: Use Case: Use Case 2—Recurring food order from specialty packaged meals

FIG. 10: Alternate embodiment—Secure Transport Bag/Box: This block diagram shows the logical elements of the secure transport bag/box.

FIG. 11: Video recording: This block diagram shows the logical elements of the secure transport bag/box video recording

FIG. 12: Container imaging system: This block diagram shows the logical elements of the secure transport bag/box x-ray imaging.

### DETAILED DESCRIPTION OF INVENTION

There is a percentage of a population that may be hesitant to order food due to trust in safety and quality. Technology is making it economically feasible to add the trust in the delivery process with advanced safety and quality processes.

Core to this invention is the secure delivery container. The delivery container can be locked and the contents can be partitioned with ability to control the temperature in each partition.

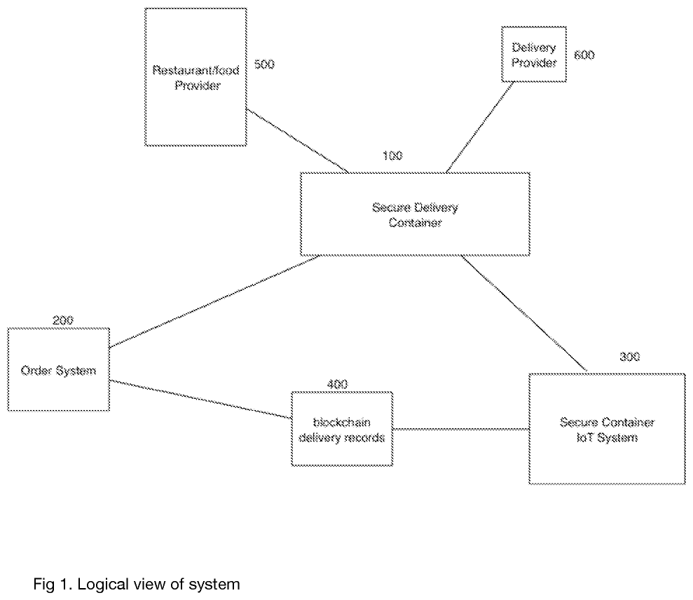

FIG. 1 shows the logical view of the block diagram of the system. The secure delivery container 100 is associated with the operation of the delivery process. The order system 200 processes customer orders that will be delivered with the secure delivery container. The Secure Container IOT system 300 controls the electronics in the secure delivery container for the safety and environmental needs. The block chain delivery records 400 securely stores all activities associated with the order process and the IOT system. The restaurant/food provider 500 uses the secure delivery container and the associated technologies to facilitate high quality preparation and processing of the order. The delivery provider 600 is responsible for secure transport of the secure delivery container to the customer.

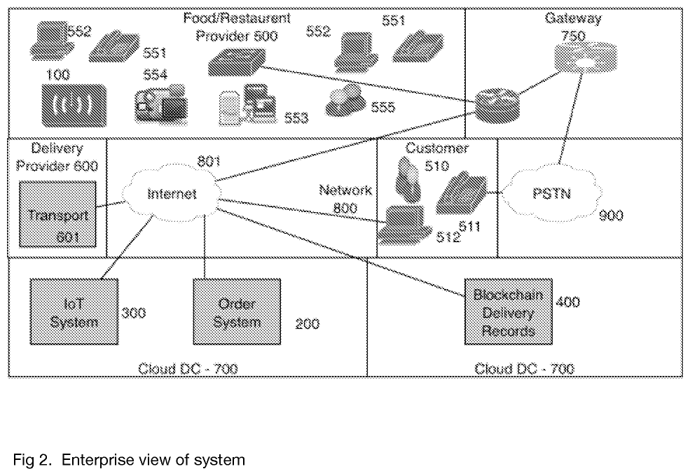

FIG. 2 shows the enterprise view of the block diagram of the system. Customer 510 can place an order using a telephone 512 with a personal profile for telephone ordering OR using a computer or mobile device 511 as a direct online order. The telephone call is established via PSTN 900 with an automated order system 200 in the cloud data center 700 or call answered by Food/Restaurant Service Provider 500 with their staff 555 using service phone 551. In both cases the order system is used by customer or service provider staff to establish the order. The order system 200 can handle web based requests as well as telephone requests. The order system also as a text messaging server that can communicate with the container when sending the unlock code to the customer. Service staff 555 is also responsible for processing the order. Video camera 554 and Machine learning system 553 are used to capture the visual processing of the order. The machine learning system also has a weighing scale to verify the quantity. Secure delivery container 100 is used to hold the prepared food items. The secure delivery container is re-usable and sent and returned from each customer by the delivery provider. IOT system 300 interacts with the secure delivery container 100 to control the electronics in the container. Blockchain delivery records 400 in cloud DC 700 is used to securely store all the data and events associated with the order and delivery process. The delivery provider 600 provides the transport 601 to physically deliver the secure delivery container 100 to the customer 510. All the communication between the devices is performed through the network 800 and gateway 750.

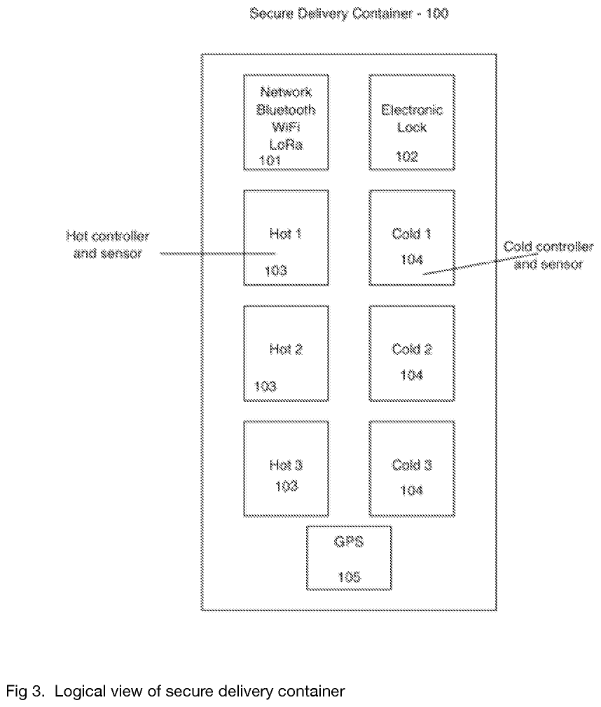

FIG. 3 shows the block diagram of the secure delivery container 100. 103 and 104 are hot and cold partitions with a controller and sensor. 102 is the electronic lock that can only be secured by the food provider and only opened by the customer. 101 is the network connection either by bluetooth or wifi to control the lock and the partition environment. The network also supports LoRa, a low power long range low bit rate network that can communicate up to 15 km using the local GPS 105 in case the contained is misplaced or lost during delivery and cannot be located.

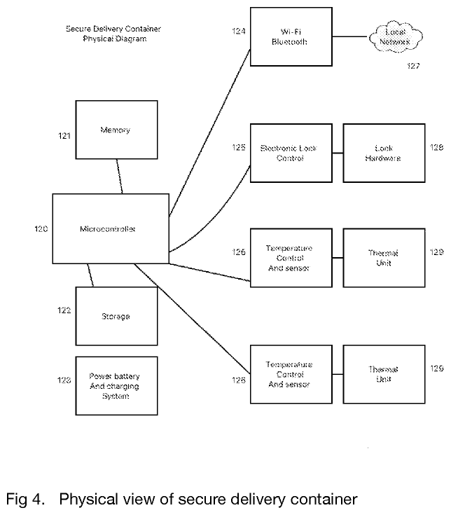

FIG. 4 shows the block diagram of the physical elements in the secure delivery container 100. Microcontroller 120 along with memory 121 and storage 122 operates the programs that control the elements in the secure delivery container. Electronic lock control 125 operates the lock hardware to open and close based on commands from the microcontroller program. Temperature control and sensor 126 operates the thermal unit 129 that dictates the temperature and environment of a specific partition. The temperature is set according the order requirements based on commands from the microcontroller program. The wifi/bluetooth 124 provides the connectivity for transfer of data from local network 127 to the microcontroller storage. Policies and settings for each order and partitions are stored as control data to program the secure delivery container. The power and battery charging system 123 powers all the electronic elements of the secure delivery container.

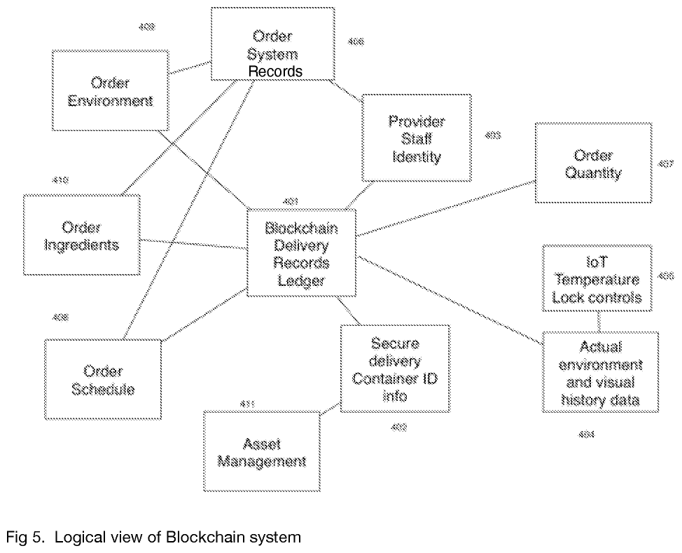

FIG. 5 depicts the block diagram of the logical elements of the Blockchain for Delivery records. Each order becomes a smart contract between the customer and the food service provider. The Blockchain delivery records ledger 401 stores information for the Order Quantity 407, order ingredients 410, Order schedule 408, Provider staff identities 403, Order Environment 409, actual environment/visual history data 404 and secure delivery container ID information 402. Order system 406 represents the data records for the order system 200 and populates the order quantity, ingredients, schedule and staff identify data to be tracked by the blockchain system. The IoT temperature, visual and Lock controls 405 populates the actual environment and visual history data.

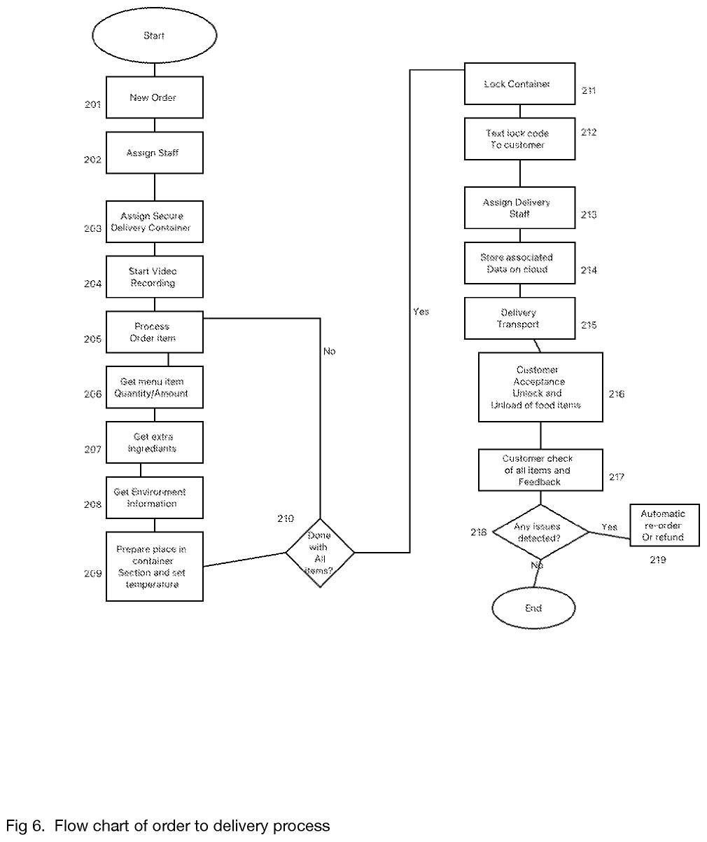

FIG. 6 depicts the program steps for executing the food order through delivery. Step 201 a manager reviews and logs a new order. Step 202 the manager assigns a staff with a specific ID and dedicated to work on the food order. Step 203 the staff assigns a secure delivery container for this specific order. Step 204 the staff starts video recording specific to this order to record the video of the items being prepared and loaded into the container. Step 205 the staff processes the order item by item. Step 206 gets the menu item with quantity/amount. Step 207 the staff gets the extra ingredients information. Step 208 the staff gets the environment settings to be used in the container partitions. Step 209, the Staff prepares the food item, validates video captured of items, weight registered and places in a specific partition section of the container and sets the temperature. Step 210, check if all items done, otherwise go back to step 205 to process next item. When all items are done, step 211 the staff locks the container. The container generates a secure lock code. An encrypted version of the lock code is stored in the order system. Step 212 the staff activates a button on the container which will send the unlock code as text to customer before it is sent to delivery staff. The container will communicate over the wifi network to the order system text messaging server to accomplish the task. Step 213 the food staff assigns a delivery staff. Step 214 all the data associated with the order are stored on the cloud. Step 215 the actual transport for the delivery is performed. Step 216 the customer accepts the delivery of the secure delivery container, unlocks using the code received and upload of the food items. Step 217 the customer checks the item for quality and submit feedback via an app. Step 218 if any major issues are detected there would be an automatic re-order or a refund issued. Step 218 utilizes data from the video analyzed using machine learning to detect any error in the creation of the order.

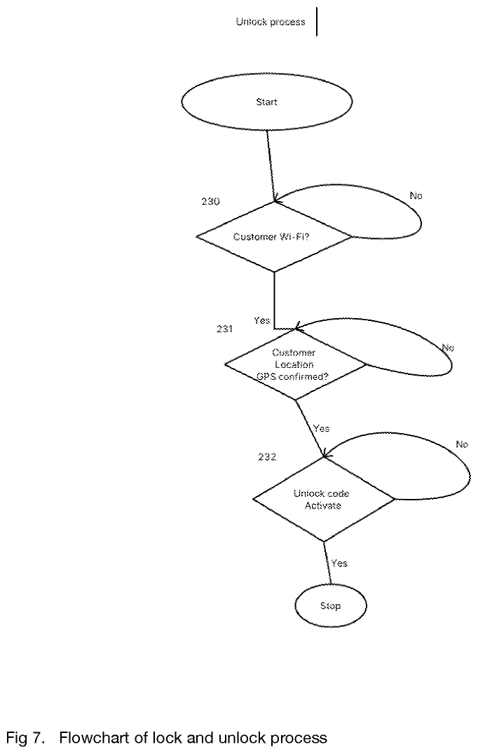

FIG. 7 depicts the container internal program steps for lock and unlock of the secure delivery container. The electronic lock uses a triple verification method before it can be unlocked. Step 230 checks and confirms if the customer's WiFi SSID from the customer's profile is detected. Step 231 checks and confirms GPS location based on the address. Step 232 checks unlock code to activate opening of the container. In an alternate embodiment a smart phone app may be used to activate the unlock code to scan and confirm the bar code on the container and use bluetooth to send the unlock command to the container.

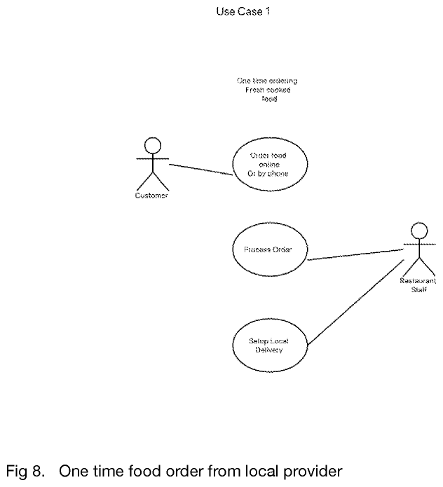

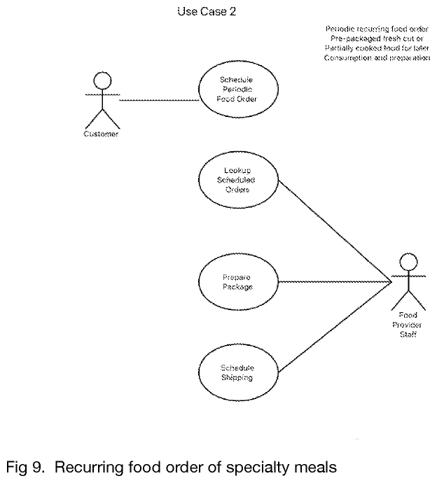

FIG. 8 and FIG. 9 depicts the two exemplary use cases where the embodiment of this invention is applicable. FIG. 8 shows use case 1, a one time ordering process to order fresh food locally. FIG. 9 shows use case 2 periodic recurring food order of pre-packaged fresh cut or partially cooked food for later consumption and preparation.

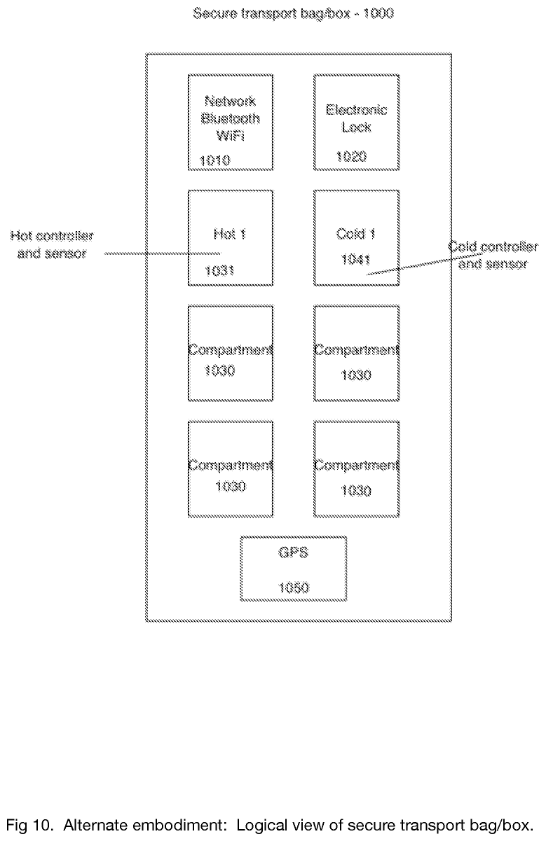

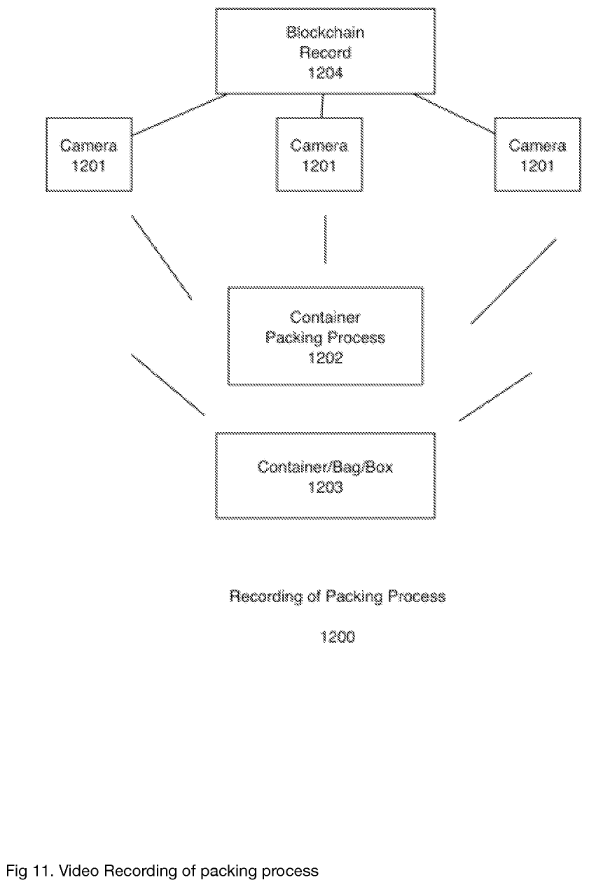

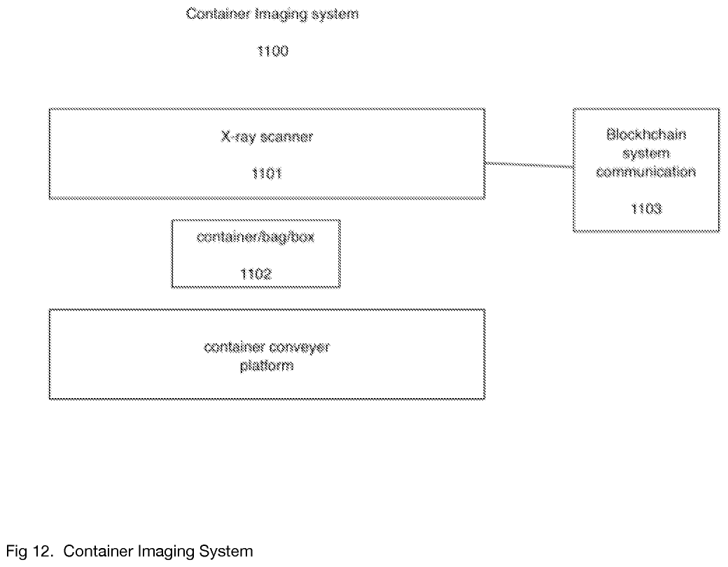

FIG. 10 depicts an alternate embodiment and enablement of the same technology for secure transport of a bag or box of personal or commercial content when traditional supply chain mechanisms are limited especially in case of disaster situations or pandemic. In the secure bag/box 1000, 1031 and 1041 are hot and cold partitions with a controller and sensor. 1020 is the electronic lock that can only be secured by the sender of the bag/box and only opened by the receiving party. 1010 is the network connection either by bluetooth or wifi to control the lock and the partition environment. The network also supports LoRa, a low power long range low bit rate network that can communicate up to 15 km using the local GPS 1050 in case the contained is misplaced or lost during delivery and cannot be located. FIG. 11 depicts as a part of the security, a video created using cameras 1201 during the bagging and packing process 1202 of the contents and are stored on the blockchain record 1204. FIG. 12 depicts third party x-ray scan 1101 images of the bag 1102 and contents are also stored as part of the blockchain records 1103. Inventory is validated and stored as a part of blockchain records. The date time and location of packing are also stored in the blockchain. In case of supply chain disruptions, this allows a new business model for private parties to assist transport urgent goods as a part of private travel. The secure bag/box provides a trusted process for third parties to handle the items. There can be transfer points to standard carriers like UPS Fedex and DHL in different cities before reaching final destination.

The computer program product may include a computer readable non-transitory storage medium (or media) having computer readable program instructions stored thereon for causing a computer processor unit to carry out aspects of the present invention.

The computer readable storage medium can be a hardware or a non-transitory virtual device that can keep, retain and store computer program instructions for use by a program instruction execution device.

While we have shown in this disclosure uses cases specific to food delivery, this invention is not limiting. There are potential applications to other scenarios, eg secure pharmaceutical, medical, e-commerce product deliveries via third parties or transport, sensitive parts deliveries (eg, automotive industry) via third parties or transport, etc. In view of this disclosure, the ordinary skill in the art can apply the present invention to other systems, while remaining within the scope of the techniques described here.

Additional advantages of this disclosure may be apparent to those skilled in the art to augment existing delivery solutions. For example, an existing food truck with frozen compartments, pharmaceutical, medical, e-commerce products may be enhanced to incorporate features of this disclosure.

### CONCLUSION

Based on the invention, such an invention will facilitate growth of the food delivery systems and reducing waste of undelivered food or food products on the shelf especially during disaster and pandemic events when there is an imbalance of supply and demand of standard providers and new supply channels are injected into the system. The invention equally applies for the product delivery of pharmaceutical, medical or e-commerce industry.

1. A system for a blockchain enabled secure food delivery process, comprising:
One or more processors and one or more memory;
a blockchain distributed digital ledger;
An artificial intelligence and machine learning process;
a secure food delivery container with a blockchain enabled electronic lock;
the secure food delivery container with multiple compartments and each compartment with their own sensors and climate controllers;
where in the system performs real time analytics of a food ordering process and the secure food delivery process;
wherein the real time analytics includes tracking environmental conditions in the secure food delivery container;
wherein the artificial intelligence includes the food provider as an independent agent and verified food preparation process;
wherein a blockchain process records to store and track the food preparation process;
wherein a blockchain process records, store and manage the secure food delivery process including the electronic lock control in the blockchain distributed ledger.

2. A system of claim 1, further comprising a server system comprising a central processing unit, a memory and a storage.

3. A system of claim 1, further comprising the secure delivery container electronic lock—comprising Wi-FI, and GPS components.

4. A system of claim 1, further comprising the real time analytics includes video and photos of the food preparation process.

5. A system of claim 1, where the blockchain storage is a decentralized network of records called blocks, which store data associated with food delivery transactions and blocks linked by a cryptographic hash algorithm.

6. A system of claim 1, where the blockchain management is an access, control of an access of public or private keys, tracking access, and detecting fraudulent access of the food delivery transactions in the blockchain distributed digital ledger.

7. A system of claim 6, further comprising the blockchain process creates a persistent smart contract between a customer and a service provider for all order details.

8. A system of claim 1, further comprising the real time analytics includes time stamps of each event during the delivery process.

9. A system of claim 3, further comprising the electronic lock with a secure code for unlock process.

10. A system of claim 1, wherein the tracking of environment comprises verifying temperature is according to the order requirements of each compartment in the secure container and attaching time stamps to track back.

11. A system of claim 1, wherein the secure container comprises a container for end to end delivery of food accessible only by a recipient after delivery.

12. A method of trusted food delivery comprising:
an order system for delivery process;
an artificial intelligence and machine learning;
messaging mechanism for secure code delivery;
food provider registration and qualification methods;
a blockchain distributed ledger;
a secure food delivery container with an electronic lock;
the secure food delivery container with multiple compartments and each compartment with their own sensors and climate controllers;
where in the system performs real time analytics of a food ordering process and the secure food delivery process;
wherein the real time analytics includes tracking environmental conditions in the secure food delivery container;
wherein the artificial intelligence includes the food provider as an independent agent and a verified food preparation process;
wherein a blockchain process records, store and manage the secure food delivery process including the electronic lock control in the blockchain distributed ledger.

13. A method of claim 12, further comprising the order system records stores quantity and ingredients of an order.

14. (canceled)

15. A method of claim 12, further comprising the artificial intelligence and machine learning system collects statistics and creates insights that detects and alerts on quality patterns associated with the food ordering and—delivery process.

16. A method of claim 12, further comprising the order system stores policies associated with a customer profile and staff profiles associated with the order process.

17. A method of claim 12, further comprising the messaging mechanism that can communicate with a smartphone app for purpose of lock and unlock process.

18. A method of claim 12, further comprising the messaging mechanism that can communicate with a smartphone app for purpose of feedback process.

19. A method of claim 16, the customer profile includes customer preferences for ordering food or/and the staff profile includes anonymous identifier and customers serviced.

20. A method of claim 12, further comprising trusted food provider as independent qualified and verified food preparation processes validated by artificial intelligence and blockchain process.

21. A blockchain device comprising;
One or more processors and one or more memory;
a blockchain distributed digital ledger;
An artificial intelligence and machine learning process;
a secure food delivery container with a blockchain enabled electronic lock;
the secure food delivery container with multiple compartments and each compartment with their own sensors and climate controllers;
where in the system performs real time analytics of a food ordering process and the secure food delivery process;
wherein the real time analytics includes tracking environmental conditions in the secure food delivery container;
wherein the artificial intelligence includes the food provider as an independent agent and verified food preparation process;
wherein a blockchain process records to store and track the food preparation process;
wherein a blockchain process records, store and manage the secure food delivery process including the electronic lock control in the blockchain distributed digital ledger.
